(19) United States
(12) Patent Application Publication
(10) Pub. No.: US 2023/0140412 A1
(43) Pub. Date: May 4, 2023

(54) LEAD GENERATING SYSTEMS AND METHODS BASED ON PREDICTED CONVERSIONS FOR A SOCIAL MEDIA PROGRAM

(71) Applicant: Meta Platforms, Inc., Menlo Park, CA (US)

(72) Inventors: Ashish Sumant, Mountain View, CA (US); Ying Sun, Berkeley, CA (US); Dongyang Li, San Francisco, CA (US)

(21) Appl. No.: 17/519,430

(22) Filed: Nov. 4, 2021

(51) Int. Cl. G06Q 30/02; G06Q 50/00; G06N 20/00

(52) U.S. Cl. CPC G06Q 30/0244; G06Q 30/0249; G06Q 30/0272; G06Q 50/01; G06N 20/00

(57) ABSTRACT

Methods, systems, and storage media for generating leads for vendors through a social media program are disclosed. Exemplary implementations may: estimate a conversion rank for an online promotion for a targeted prospect based at least in part on historical data of conversion ranks for a sample of the targeted prospect; simulate the online promotion to the sample of the targeted prospect; calculate a likelihood of conversion based on the simulating of the online promotion to the sample of the targeted prospect; and cause display of the likelihood of conversion as a confidence score.

### TECHNICAL FIELD

The present disclosure generally relates to lead generating systems and methods based on predicted conversions and more particularly to generating leads for vendors through a social media program.

### BACKGROUND

Most small and medium size businesses (SMBs) need to advertise for products or services that they are selling. Often, these businesses rely on word-of-mouth “advertising” or referrals. Social media sites offer both “organic” (e.g., without paid advertising) and paid advertising to reach potential customers. SMBs often need to reach a wider audience and/or reach that audience faster than can be done by traditional organic reach. For most SMBs, this means paid advertising.

While paid advertising may seem simple (e.g., paying a fee to run advertisements), effective online advertising has a technical component. Indeed, most online advertising is pay-per-click, meaning that it can quickly get very expensive if the people clicking on those ads are not qualified leads. Often, a marketing expert or dedicated team of advertising professionals is required to set up the ad campaigns to target qualified leads, and then continue to monitor those ads for effectiveness and make adjustments to achieve the desired result.

### BRIEF SUMMARY

The subject disclosure provides for systems and methods for lead generation based on predicted conversions for a social media program. A user is presented with machine learning predictions for an advertising campaign or online promotion, to better target ads to an audience on a social media program. In an example, a user is provided with a contextual experience, via a user interface, to select various parameters (e.g., advertising budget, location, audience). The user is then presented with a predicted outcome for advertising on a social media program.

One aspect of the present disclosure relates to a method for generating leads for vendors through a social media program. The method may include estimating a conversion rank for an online promotion for a targeted audience or prospect for a product or service, based at least in part on historical data of conversion ranks for a sample of the targeted audience. The online promotion may be launched through a social media program. The method may include simulating the online promotion to the sample of the targeted audience. The method may include calculating a likelihood of conversion based on the simulating of the online promotion to the sample of the targeted audience. The method may include causing display of the likelihood of conversion as a confidence score.

Another aspect of the present disclosure relates to a system configured for generating leads for vendors through a social media program. The system may include one or more hardware processors configured by machine-readable instructions. The processor(s) may be configured to estimate a conversion rank for an online promotion for a targeted audience based at least in part on historical data of conversion ranks for a sample of the targeted audience, and at least one signal of prior performance of a prior ad campaign. The online promotion may be launched through a social media program. The processor(s) may be configured to simulate the online promotion to the sample of the targeted audience. The processor(s) may be configured to calculate via machine learning (ML), an outcome for the online promotion including at least a likelihood of conversion, based on the simulating of the online promotion to the sample of the targeted audience. The processor(s) may be configured to cause display of the likelihood of conversion as a confidence score.

Yet another aspect of the present disclosure relates to a non-transient computer-readable storage medium having instructions embodied thereon, the instructions being executable by one or more processors to perform a computer-implemented method for generating leads for vendors through a social media program. The method may include estimating a conversion rank for an online promotion for a targeted audience based at least in part on historical data of conversion ranks for a sample of the targeted audience. The online promotion may be launched through a social media program. The method may also include simulating the online promotion to the sample of the targeted audience by an outcome prediction algorithm. The method may also include training a machine learning (ML) model for calculating a confidence score corresponding to the likelihood of conversion, based at least in part on sample data and the historical data. The method may also include implementing the ML model to predict a performance of the online promotion. The method may also include generating a predication of the performance based on outputs of the ML model. The method may also include causing display of the confidence score indicating outcome for winnable impressions of an audience reach of the ad campaign and likelihood of the conversion.

Still another aspect of the present disclosure relates to a system configured for generating leads for vendors through a social media program. The system may include means for estimating a conversion rank for an online promotion for a targeted audience based at least in part on historical data of conversion ranks for a sample of the targeted audience. The online promotion may be launched through a social media program. The system may include means for simulating the online promotion to the sample of the targeted audience. The system may include means for calculating a likelihood of conversion based on the simulating of the online promotion to the sample of the targeted audience. The system may include means for causing display of the likelihood of conversion as a confidence score.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1 and 2 illustrate a user interface presenting a contextual experience for predicting outcome of advertising on a social media program based on machine learning predictions, according to certain aspects of the disclosure.

FIGS. 3 and 4 illustrate a user interface displaying a conversion confidence score for predicting outcome of advertising on a social media program based on machine learning predictions, according to certain aspects of the disclosure.

FIG. 5 illustrates a two-tower sparse neural network (TTSN) which may be implemented for predicting outcome of advertising on a social media program based on machine learning predictions, according to certain aspects of the disclosure.

FIG. 6 illustrates a system configured for lead generation including predicted conversions, in accordance with one or more implementations.

FIG. 7 illustrates an example flow diagram for lead generation including predicted conversions, according to certain aspects of the disclosure.

FIG. 8 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Conventionally, small and medium size businesses (SMBs) purchase ads to run on social media programs by selecting a target audience and a budget or “ad spend.” This model can make it difficult for the SMB to assess the effectiveness of their advertising in advance of running the ads. As a result, many ad campaigns start off as “hit-and-miss” and need to be refined over time. Running ineffective ad campaigns increases the cost of advertising. In addition, the SMB may give up, thinking that advertising on social media just is not effective or worth the expense.

The subject disclosure provides for systems and methods for lead generation including predicted conversions. The subject disclosure provides for systems and methods for lead generation including predicted conversions. A user is presented with a contextual experience, via a user interface, for previewing an outcome of an online promotion that is based on machine learning predictions. For example, the user may select various parameters (e.g., advertising budget, location, audience), and is then presented with a predicted outcome for advertising on a social media program.

Implementations described herein address the aforementioned shortcomings and other shortcomings by providing greater insight for small businesses on the value of potential leads during initial setup of an online promotion on a social media program. In an example, a user interface presents a contextual experience for predicting outcome of advertising on a social media program based on machine learning predictions.

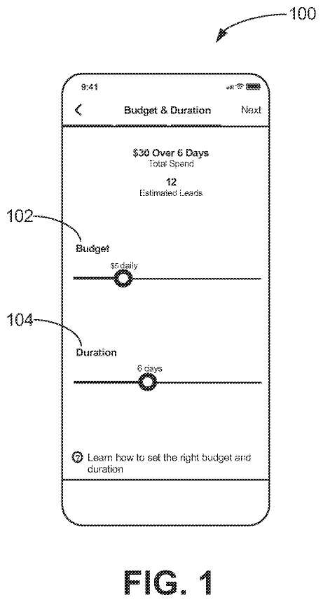

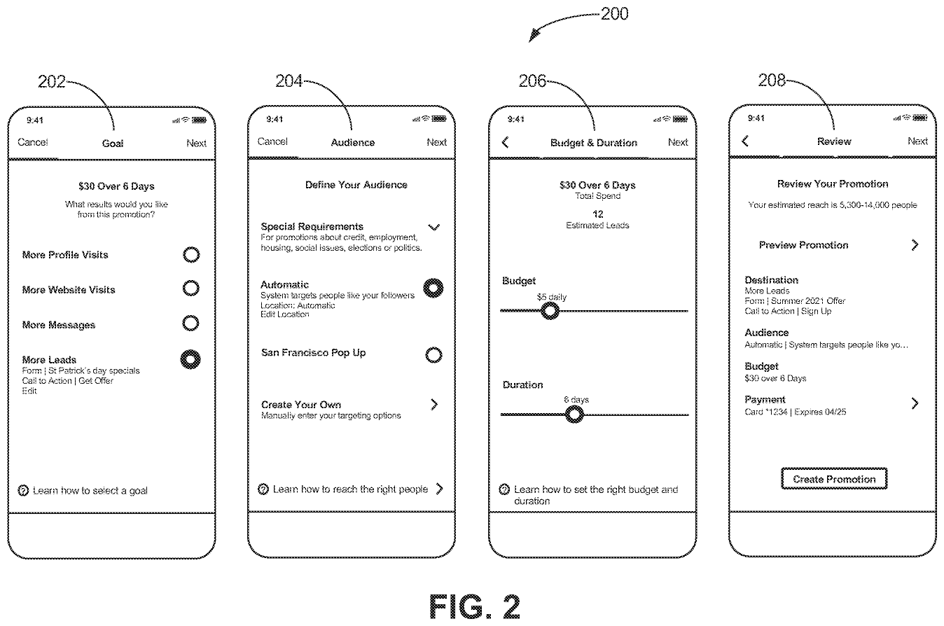

FIGS. 1 and 2 illustrate a user interface presenting a contextual experience for predicting outcome of advertising on a social media program based on machine learning predictions, according to certain aspects of the disclosure. FIG. 1 shows an example user interface 100 which may be displayed for a user. In this example, the user is an advertiser or potential advertiser on the social media program. The user is allowed to select a budget 102 for a particular online promotion, and a duration 104 for the online promotion. The user may make any appropriate selections, from which the total cost and estimated conversions (e.g., leads) is calculated and displayed for the user based on these selections. Other selections may also be made available to the user and are not limited to the examples shown in FIG. 1.

FIG. 2 shows an example of a series of screens 200 that may be displayed in the user interface, from which the user may make selections. Examples include, but are not limited to, the user selecting a goal 202 for the online promotion, an audience 204 for the online promotion, a budget and duration 206 (see, e.g., FIG. 1) for the online promotion, and a review 208. The goal 202 allows the user to select goals for the online promotion, such as how many profile visits, website visits, messages, and/or leads that the advertiser would like to achieve. The audience 204 allows the user to select special requirements, automate the advertisement (or aspects thereof), location of the audience, and/or create the user's own audience description. The review screen allows the user to review the selections prior to receiving a predicted outcome for the selections for the online promotion.

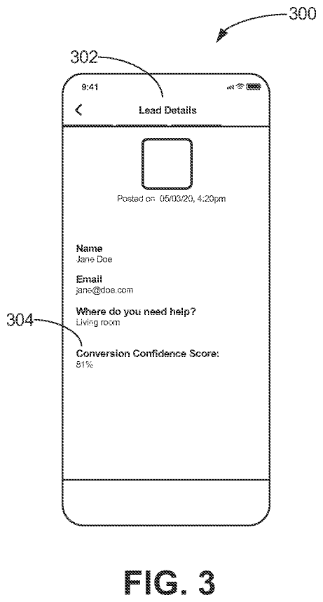

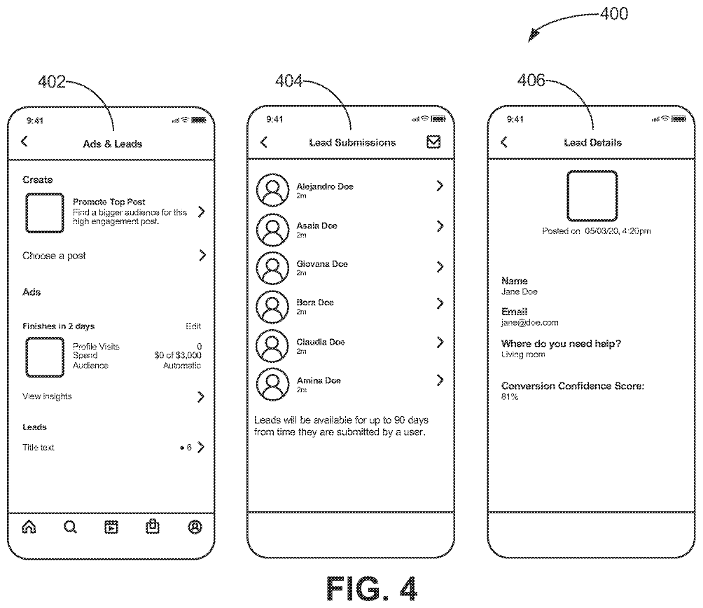

FIGS. 3 and 4 illustrate a user interface 300 displaying a conversion confidence score for predicting outcome of advertising on a social media program based on machine learning predictions, according to certain aspects of the disclosure. The output in FIG. 3 shows lead details 302 which have been predicted for an online promotion based on the user selections (e.g., as illustrated in FIG. 2). In particular, FIG. 3 shows an example of a conversion confidence score 304. In this example, the conversion confidence score 304 is calculated to be about 81%. This means that, based on the user's selections, there is an 81% chance that a particular online promotion will result in the desired outcome of the advertiser. The advertiser can decide to run the online promotion based on this score 304 or return to the selections to make changes (e.g., to increase budget, location, audience aspects, etc.).

FIG. 4 shows a user interface 400 with example advertisements and corresponding leads 402, lead submissions 404, and lead details 406. In an example, the user can select a particular online promotion, and ads within the campaign to see a list of audience members who interacted with the ad (i.e., “leads”). The user can also select one of the leads for specific information about that lead, including the conversion confidence score.

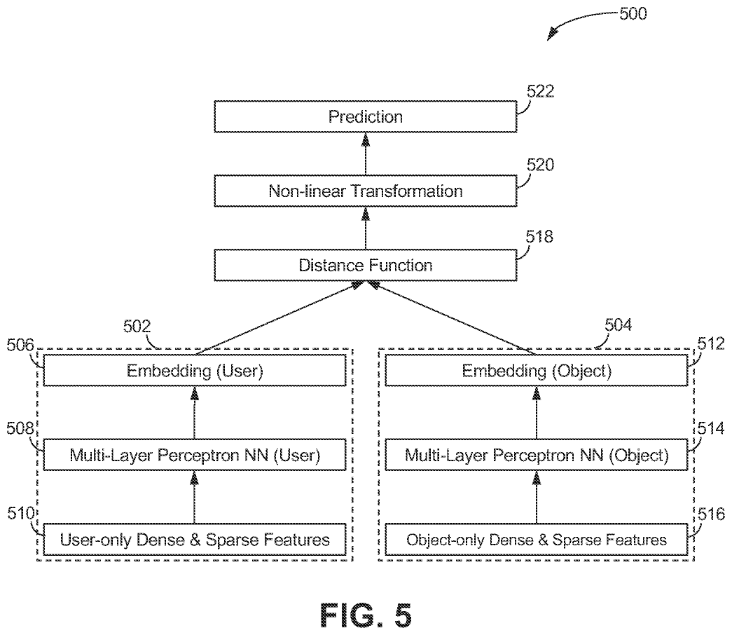

FIG. 5 illustrates a two-tower sparse neural network (TTSN) 500 which may be implemented for predicting outcome of advertising on a social media program based on machine learning predictions, according to certain aspects of the disclosure. The TTSN 500 may receive user input 502 and/or object input 504. Example user input 502 includes user-only dense and sparse features 510, multiple-layer perceptron 508, an embedding 506. Example object input 504 includes object-only dense and sparse features 516, multi-layer perceptron 514 and embedding 512.

The user input 502 and object input 504 may be input to a distance function 518 and undergo non-linear transformation 520 to arrive as a prediction 522. It is noted that the TTSN 500 process flow illustrated in FIG. 5 is only exemplary and not intended to be limiting. Still other neural networks and other machine learning algorithms now known or later developed, may be implemented to carry out the operations shown and described herein to predict outcome of advertising on a social media program.

The disclosed system(s) address a problem in traditional lead generation and conversion prediction techniques tied to computer technology, namely, the technical problem of targeting advertisements to an audience on a social media program. Without some foresight into the audience, many online promotions are ineffective, increasing the cost and causing some advertisers to pull their ads. The disclosed system solves this technical problem by providing a solution also rooted in computer technology, namely, by providing for generating leads for vendors through a social media program. The disclosed subject technology further provides improvements to the functioning of the computer itself because it improves processing and efficiency in lead generation including predicted conversions.

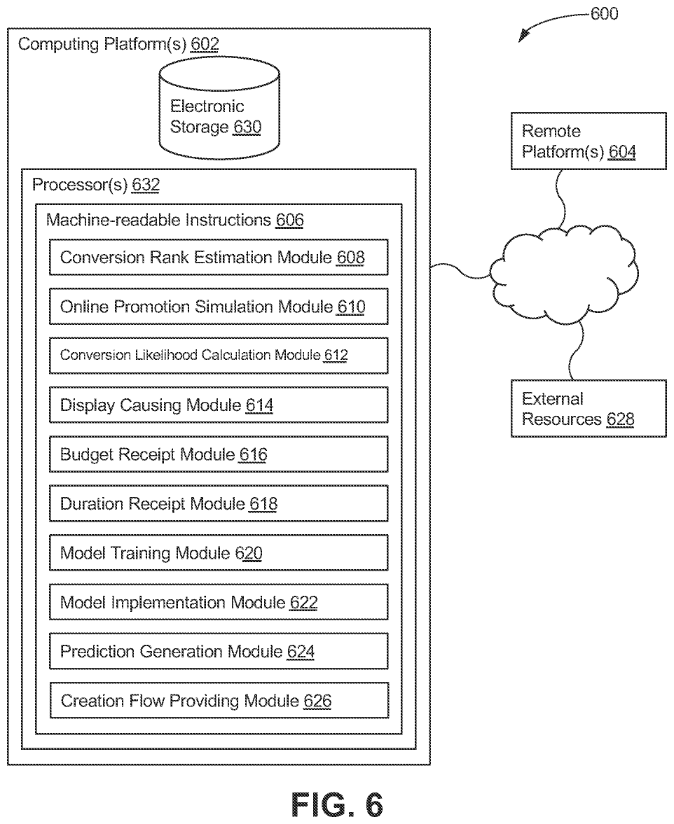

FIG. 6 illustrates a system 600 configured for lead generation including predicted conversions, according to certain aspects of the disclosure. In some implementations, system 600 may include one or more computing platforms 602. Computing platform(s) 602 may be configured to communicate with one or more remote platforms 604 according to a client/server architecture, a peer-to-peer architecture, and/or other architectures. Remote platform(s) 604 may be configured to communicate with other remote platforms via computing platform(s) 602 and/or according to a client/server architecture, a peer-to-peer architecture, and/or other architectures. Users may access system 600 via remote platform(s) 604.

Computing platform(s) 602 may be configured by machine-readable instructions 606. Machine-readable instructions 606 may include one or more instruction modules. The instruction modules may include computer program modules. The instruction modules may include one or more of conversion rank estimation module 608, online promotion simulation module 610, conversion likelihood calculation module 612, display causing module 614, budget receipt module 616, duration receipt module 618, model training module 620, model implementation module 622, prediction generation module 624, creation flow providing module 626, and/or other instruction modules.

Conversion rank estimation module 608 may be configured to estimate a conversion rank for an online promotion for a targeted audience based at least in part on historical data of conversion ranks for a sample of the targeted audience. The “conversion rank” is the number of people who interact with an advertisement, divided by the number times the advertisement is shown to an audience. For example, if an advertisement is shown 10 times and 3 people from the audience interact with the advertisement, then the conversion rank is 30%. Both the advertiser and the advertising program seek to maximize the conversion rank for an effective online promotion. Interacting with an advertisement may be defined by the advertiser and/or the advertising program and may include any sort of desired interaction (e.g., clicking the ad, calling the advertiser).

The online promotion may be launched through a social media program. The social media program may include a first party program. By way of non-limiting example, the historical data may include at least one of prior performance of similar campaigns, prior performance of the campaign, prior responses of targeted audiences, and prior responses of lookalike audiences. The prior performance may be for a same type of objective. By way of non-limiting example, the historical data comprises at least one of time spent on the program, engagement and time spent on content of the program, location, and demographic.

Online promotion simulation module 610 may be configured to simulate the online promotion to the sample of the targeted audience. Simulating the ad campaign enables the advertiser to “preview” audience response. For example, the advertiser may propose to run an advertisement with a particular budget, in a particular location, to a defined audience. The simulation can predict the number of people who are likely to interact with that advertisement based on any previously observed or “historical” data.

Simulating the ad campaign may be based on an outcome prediction algorithm. The outcome prediction algorithm may estimate a conversion rank on a campaign for a sample of targeted audience based on historical impression conversions. The outcome prediction algorithm may simulate an auction on sampled audience impression data to calculate a likelihood of the campaign winning the auction to project reach and outcome of the campaign.

In some implementations, simulating the online promotion may include estimating an outcome for the ad campaign. By way of non-limiting example, the outcome may include at least one of number of leads, number of appointments, number of orders, number of messages, and number of calls. By way of non-limiting example, the outcome may be based on prior prospects who at least dropped out, were unresponsive, and/or did not convert to a customer for a prior ad campaign. The outcome may be based on a business metric of the advertiser. By way of non-limiting example, the business metric may include at least one of business verticals of the advertiser, advertiser tenure on the social media program, advertiser customer base, and advertiser monthly ad spend.

Conversion likelihood calculation module 612 may be configured to calculate a likelihood of lead conversion based on the simulating of the online promotion to the sample of the targeted audience. Conversion can be calculated based on prior audience interaction with the same or similar advertising parameters that have been observed in the past for the same or similar audience.

Display causing module 614 may be configured to cause display of the likelihood of lead conversion as a confidence score. The likelihood of lead conversion may include the confidence score. The confidence score may be from 0-100. The confidence score may indicate a likelihood that a prospective customer interaction with the ad campaign turns into a business transaction. The confidence score may be based on a combination of available data about a prospect and a machine learnt model based on data collected over time.

In some implementations, the confidence score may be based on sample data. The sample data may include examples of prior prospects who converted and examples of prior prospects who dropped out. By way of non-limiting example, the sample data may include at least one of data regarding followers, users followed, categories of content engaged with, time spent on the content on the program, engagement and time, location presence, and demographic.

Budget receipt module 616 may be configured to receive a budget for the online promotion. The budget for an online promotion may be selected based on any number of factors, including but not limited to, the advertiser's budget for a particular social media program, time, product or service being advertised. External factors may also play a role, such as competition for an audience. For example, competition may be higher (and thus a higher price) for fast food advertisements around mealtime, and the competition may be lower (and thus a lower price) for high end watches or jewelry.

Duration receipt module 618 may be configured to receive a duration for the online promotion. Duration of an online promotion may depend on any number of factors, including but not limited to, the advertiser's timeline for advertising a particular product or service. For example, the advertiser may only want to run an online promotion during a holiday season, or during a particular time of year (e.g., back-to-school in August).

Model training module 620 may be configured to train a machine learning (ML) model for calculating the confidence score based at least in part on the historical data. Model training module 620 may be configured to train training a machine learning (ML) model for calculating the confidence score based at least in part on at least one signal. The at least one signal may include prior performance of an advertiser ad campaign for a same type of objective. The at least one signal may include prior performance of another similar advertiser ad campaign for a same type of objective. The at least one signal my include prior responses of targeted audience selection profile for a campaign with other prior campaigns of the same objective. By way of non-limiting example, the at least one signal may include at least one of followers and people followed, categories of content engaged with, time spent on the content on the same social media program and account, engagement and time spent on the content on other social media programs with a linked account, location presence, and demographic signals. The at least one signal may include prior responses of lookalike audience of a targeted audience. By way of non-limiting example, the lookalike audience score is based on at least one of time spent on content, engagement and time spent on content on another social media program with a linked account, location presence, and demographic data.

Model implementation module 622 may be configured to implement the ML model to predict a performance of the online promotion. After the ML model has been trained, it is ready for use in predicting audience response to online promotions. Of course, the ML model may be updated over time, and irrelevant ML models may be discarded in favor of new, more accurate ML models. Different ML models may be selected for implementation, e.g., based on aspects of the online promotion. Examples include, but are not limited to, separate ML models for different times of year, different target audiences, products versus services, etc.

Prediction generation module 624 may be configured to generate a predication of the performance based on outputs of the ML model. By way of non-limiting example, the ML model may include at least one of a two tower sparse neural network (TTSN), a convolutional neural network (CNN), a recurrent neural network (RNN), a generalized regression neural network (GRNN), deep learning, and supervised and/or unsupervised trained model. Still other models now known or later developed, are contemplated as being within the scope of the disclosure herein, as will be readily apparent to those having ordinary skill in the art after becoming familiar with the teachings herein.

Creation flow providing module 626 may be configured to provide ad campaign creation flow that includes an estimate of the outcome. By way of non-limiting example, providing the ad campaign creation flow may include at least one of receiving a user selection of leads, website visits, and/or other measurable outcome metrics. Providing the ad campaign creation flow may include estimating a conversion rank of the ad campaign for a sample of targeted audience based on historical impression conversion possibility. By way of non-limiting example, providing ad campaign creation flow may include causing display of the estimated conversion rank based on at least one of allocated budget, location, and/or other measurable input metric. Providing the ad campaign creation flow may include simulating an auction on a sampled audience's impression data to determine a likelihood of the ad campaign winning the auction. Providing the ad campaign creation flow may include causing display of a projected reach and outcomes of the campaign. Providing the ad campaign creation flow may include input for additional signals while estimating user conversion rank on the ad campaign to improve accuracy of the simulation. The additional signals may include data from an advertiser.

In some implementations, computing platform(s) 602, remote platform(s) 604, and/or external resources 628 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 602, remote platform(s) 604, and/or external resources 628 may be operatively linked via some other communication media.

A given remote platform 604 may include one or more processors configured to execute computer program modules. The computer program modules may be configured to enable an expert or user associated with the given remote platform 604 to interface with system 600 and/or external resources 628, and/or provide other functionality attributed herein to remote platform(s) 604. By way of non-limiting example, a given remote platform 604 and/or a given computing platform 602 may include one or more of a server, a desktop computer, a laptop computer, a handheld computer, a tablet computing platform, a NetBook, a Smartphone, a gaming console, and/or other computing platforms.

External resources 628 may include sources of information outside of system 600, external entities participating with system 600, and/or other resources. In some implementations, some or all of the functionality attributed herein to external resources 628 may be provided by resources included in system 600.

Computing platform(s) 602 may include electronic storage 630, one or more processors 632, and/or other components. Computing platform(s) 602 may include communication lines, or ports to enable the exchange of information with a network and/or other computing platforms. Illustration of computing platform(s) 602 in FIG. 6 is not intended to be limiting. Computing platform(s) 602 may include a plurality of hardware, software, and/or firmware components operating together to provide the functionality attributed herein to computing platform(s) 602. For example, computing platform(s) 602 may be implemented by a cloud of computing platforms operating together as computing platform(s) 602.

Electronic storage 630 may comprise non-transitory storage media that electronically stores information. The electronic storage media of electronic storage 630 may include one or both of system storage that is provided integrally (i.e., substantially non-removable) with computing platform(s) 602 and/or removable storage that is removably connectable to computing platform(s) 602 via, for example, a port (e.g., a USB port, a firewire port, etc.) or a drive (e.g., a disk drive, etc.). Electronic storage 630 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 630 may include one or more virtual storage resources (e.g., cloud storage, a virtual private network, and/or other virtual storage resources). Electronic storage 630 may store software algorithms, information determined by processor(s) 632, information received from computing platform(s) 602, information received from remote platform(s) 604, and/or other information that enables computing platform(s) 602 to function as described herein.

Processor(s) 632 may be configured to provide information processing capabilities in computing platform(s) 602. As such, processor(s) 632 may include one or more of a digital processor, an analog processor, a digital circuit designed to process information, an analog circuit designed to process information, a state machine, and/or other mechanisms for electronically processing information. Although processor(s) 632 is shown in FIG. 6 as a single entity, this is for illustrative purposes only. In some implementations, processor(s) 632 may include a plurality of processing units. These processing units may be physically located within the same device, or processor(s) 632 may represent processing functionality of a plurality of devices operating in coordination. Processor(s) 632 may be configured to execute modules 608, 610, 612, 614, 616, 618, 620, 622, 624, and/or 626, and/or other modules. Processor(s) 632 may be configured to execute modules 608, 610, 612, 614, 616, 618, 620, 622, 624, and/or 626, and/or other modules by software; hardware; firmware; some combination of software, hardware, and/or firmware; and/or other mechanisms for configuring processing capabilities on processor(s) 632. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 608, 610, 612, 614, 616, 618, 620, 622, 624, and/or 626 are illustrated in FIG. 6 as being implemented within a single processing unit, in implementations in which processor(s) 632 includes multiple processing units, one or more of modules 608, 610, 612, 614, 616, 618, 620, 622, 624, and/or 626 may be implemented remotely from the other modules. The description of the functionality provided by the different modules 608, 610, 612, 614, 616, 618, 620, 622, 624, and/or 626 described below is for illustrative purposes, and is not intended to be limiting, as any of modules 608, 610, 612, 614, 616, 618, 620, 622, 624, and/or 626 may provide more or less functionality than is described. For example, one or more of modules 608, 610, 612, 614, 616, 618, 620, 622, 624, and/or 626 may be eliminated, and some or all of its functionality may be provided by other ones of modules 608, 610, 612, 614, 616, 618, 620, 622, 624, and/or 626. As another example, processor(s) 632 may be configured to execute one or more additional modules that may perform some or all of the functionality attributed below to one of modules 608, 610, 612, 614, 616, 618, 620, 622, 624, and/or 626.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a first user may share an object to the social-networking system. The object may be associated with a concept node connected to a user node of the first user by an edge. The first user may specify privacy settings that apply to a particular edge connecting to the concept node of the object or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example, and not by way of limitation, one or more objects may be visible to a user's “Trending” page. In particular embodiments, an object may correspond to a particular user. The object may be content associated with the particular user or may be the particular user's account or information stored on the social-networking system, or other computing system. As an example, and not by way of limitation, a first user may view one or more second users of an online social network through a “People You May Know” function of the online social network, or by viewing a list of friends of the first user. As an example, and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example, and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example, and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example, and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example, and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example, and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example, and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example, and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example, and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example, and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example, and not by way of limitation, the social-networking system may send a reminder to the user to confirm his or her privacy settings every six months or after every ten photo posts. In particular embodiments, privacy settings may also allow users to control access to the objects or information on a per-request basis. As an example, and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

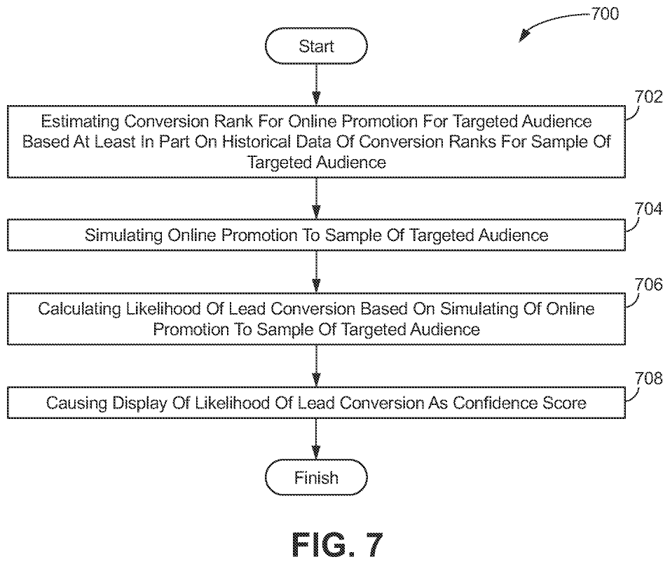

FIG. 7 illustrates an example flow diagram (e.g., process 700) for lead generation including predicted conversions, according to certain aspects of the disclosure. For explanatory purposes, the example process 700 is described herein with reference to FIGS. 1-6. Further for explanatory purposes, the steps of the example process 700 are described herein as occurring in serial, or linearly. However, multiple instances of the example process 700 may occur in parallel. For purposes of explanation of the subject technology, the process 700 will be discussed in reference to FIGS. 1-6.

At a step 702, the process 700 may include estimating a conversion rank for an online promotion for a targeted audience based at least in part on historical data of conversion ranks for a sample of the targeted audience. The online promotion may be launched through a social media program. At a step 704, the process 700 may include simulating the online promotion to the sample of the targeted audience. At a step 706, the process 700 may include calculating a likelihood of lead conversion based on the simulating of the online promotion to the sample of the targeted audience. At a step 708, the process 700 may include causing display of the likelihood of lead conversion as a confidence score.

For example, as described above in relation to FIGS. 1-6, at a step 702, the process 700 may include estimating a conversion rank for an online promotion for a targeted audience based at least in part on historical data of conversion ranks for a sample of the targeted audience, through conversion rank estimation module 608. The online promotion may be launched through a social media program. At a step 704, the process 700 may include simulating the online promotion to the sample of the targeted audience, through online promotion simulation module 610. At a step 706, the process 700 may include calculating a likelihood of lead conversion based on the simulating of the online promotion to the sample of the targeted audience, through conversion likelihood calculation module 612. At a step 708, the process 700 may include causing display of the likelihood of lead conversion as a confidence score, through display causing module 614.

According to an aspect, the process 700 further includes receiving a budget for the online promotion.

According to an aspect, the process 700 further includes receiving a duration for the online promotion.

According to an aspect, the social media program comprises a first party program.

According to an aspect, the historical data comprises at least one of prior performance of similar campaigns, prior performance of the campaign, prior responses of targeted audiences, and prior responses of lookalike audiences.

According to an aspect, the prior performance is for a same type of objective.

According to an aspect, the historical data comprises at least one of time spent on the program, engagement and time spent on content of the program, location, and demographic.

According to an aspect, the likelihood of lead conversion comprises the confidence score.

According to an aspect, the confidence score is from 0-100.

According to an aspect, the process 700 further includes training a machine learning (ML) model for calculating the confidence score based at least in part on the historical data.

According to an aspect, the process 700 further includes implementing the ML model to predict a performance of the online promotion.

According to an aspect, the process 700 further includes generating a predication of the performance based on outputs of the ML model.

According to an aspect, the confidence score is based on sample data.

According to an aspect, the sample data comprises examples of prior prospects who converted, examples of prior prospects who dropped out.

According to an aspect, the sample data comprises at least one of data regarding followers, users followed, categories of content engaged with, time spent on the content on the program, engagement and time, location presence, and demographic.

According to an aspect, the ML model comprises at least one of a two tower sparse neural network (TTSN), a convolutional neural network (CNN), a recurrent neural network (RNN), a generalized regression neural network (GRNN), deep learning, and supervised and/or unsupervised trained model.

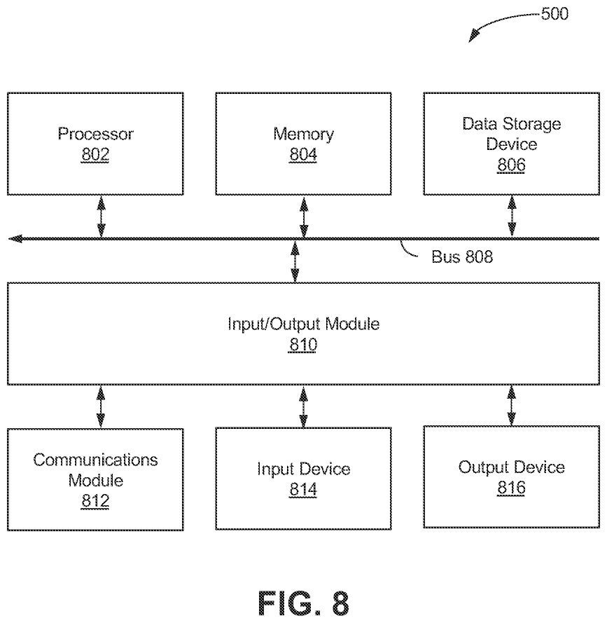

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

Computer system 800 (e.g., server and/or client) includes a bus 808 or other communication mechanism for communicating information, and a processor 802 coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as an LCD (liquid crystal display) monitor, for displaying information to the user.

According to one aspect of the present disclosure, the above-described gaming systems can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in the main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires that comprise bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 800 reads game data and provides a game, information may be read from the game data and stored in a memory device, such as the memory 804. Additionally, data from the memory 804 servers accessed via a network the bus 808, or the data storage 806 may be read and loaded into the memory 804. Although data is described as being found in the memory 804, it will be understood that data does not have to be stored in the memory 804 and may be stored in other memory accessible to the processor 802 or distributed among several media, such as the data storage 806.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for generating leads for vendors through a social media program, comprising:
estimating a conversion rank for an online promotion for a targeted audience for a product or service, based at least in part on historical data of conversion ranks for a sample of the targeted audience, the online promotion launched through a social media program, wherein the conversion rank is based on a number of prospects in the targeted audience and a launch frequency of the online promotion;
simulating the online promotion to the sample of the targeted audience;
calculating a likelihood of conversion based on the simulating of the online promotion to the sample of the targeted audience;
training a machine learning (ML) model for calculating a confidence score corresponding to the likelihood of conversion, based at least in part on sample data and the historical data;
implementing the ML model to predict a performance of the online promotion;
generating a predication of the performance based on outputs of the ML model; and
causing display of the confidence score and the predication of the performance, wherein the online promotion is selected to be launched to the targeted audience through the social media program based on the confidence score and the predication of the performance.

2. The computer-implemented method of claim 1, further comprising:
receiving a budget for the online promotion; and
receiving a duration for the online promotion.

3. The computer-implemented method of claim 1, wherein the social media program comprises a first party program.

4. The computer-implemented method of claim 1, wherein the historical data comprises at least one of prior performance of similar campaigns, prior performance of the campaign, prior responses of targeted prospects, and prior responses of lookalike audiences.

5. The computer-implemented method of claim 4, wherein the prior performance is for a same type of objective.

6. The computer-implemented method of claim 1, wherein the historical data comprises at least one of time spent on the program, engagement and time spent on content of the program, location, and demographic.

7. The computer-implemented method of claim 1, wherein the likelihood of conversion comprises the confidence score.

8. The computer-implemented method of claim 1, wherein the confidence score is from 0-100.

9. A system configured for generating leads for vendors through a social media program, comprising:
one or more hardware processors configured by machine-readable instructions to:
estimate a conversion rank for an online promotion for a targeted audience based at least in part on historical data of conversion ranks for a sample of the targeted audience, and at least one signal of prior performance of a prior ad campaign, the online promotion launched through a social media program, wherein the conversion rank is based on a number of prospects in the targeted audience and a launch frequency of the online promotion;
simulate, via a machine learning (ML) model, the online promotion to the sample of the targeted audience;
calculate, in response to the ML model, an outcome for the online promotion including at least a likelihood of conversion, based on the simulating of the online promotion to the sample of the targeted audience; and
cause display of the likelihood of conversion as a confidence score and the outcome for the online promotion, wherein the online promotion is selected to be launched to the targeted audience through the social media program based on the confidence score and the outcome for the online promotion.

10. The system of claim 9, wherein the one or more hardware processors are further configured by machine-readable instructions to:
receive a budget for the online promotion; and
receive a duration for the online promotion.

11. The system of claim 9, wherein the social media program comprises a first party program.

12. The system of claim 9, wherein the historical data comprises at least one of prior performance of similar campaigns, prior performance of the campaign, prior responses of targeted prospects, and prior responses of lookalike audiences.

13. The system of claim 12, wherein the prior performance is for a same type of objective.

14. The system of claim 9, wherein the historical data comprises at least one of time spent on the program, engagement and time spent on content of the program, location, and demographic.

15. The system of claim 9, wherein the likelihood of lead conversion comprises the confidence score.

16. The system of claim 9, wherein the confidence score is from 0-100.

17. The system of claim 9, wherein the one or more hardware processors are further configured by machine-readable instructions to:
train the machine learning (ML) model for calculating the confidence score based at least in part on the historical data;
implement the ML model to predict a performance of the online promotion; and
generate a predication of the performance based on outputs of the ML model;
wherein the confidence score is based on sample data.

18. The system of claim 9, wherein simulating the online promotion is based on an outcome prediction algorithm

19. The system of claim 18, wherein the outcome prediction algorithm simulates an auction on sampled audience impression data to calculate a likelihood of the online promotion winning the auction to project reach and outcome of the campaign.

20. A non-transitory computer-readable storage medium having instructions embodied thereon, the instructions being executable by one or more processors to perform a computer-implemented method for generating leads for vendors through a social media program, the method comprising:
estimating a conversion rank for an online promotion for a targeted audience based at least in part on historical data of conversion ranks for a sample of the targeted audience, the online promotion launched through a social media program, wherein the conversion rank is based on a number of prospects in the targeted audience and a launch frequency of the online promotion;
simulating by a machine learning (ML) model, the online promotion to the sample of the targeted audience by an outcome prediction algorithm;
calculating, based on the simulating by the ML model, an outcome of the online promotion based on at least one signal, the outcome including at least a likelihood of conversion based on the simulating of the online promotion to the sample of the targeted audience, the signal based on prior performance of a same or similar online promotion; and
causing display of a confidence score indicating outcome for winnable impressions of an audience reach of the ad campaign and likelihood of the conversion, wherein the online promotion is selected to be launched to the targeted audience through the social media program based on the confidence score and the predication of the performance.
